(19) United States
(12) Patent Application Publication
(10) Pub. No.: US 2019/0119017 A1
(43) Pub. Date: Apr. 25, 2019

(54) CONTAINERS

(71) Applicant: Inline Plastics Corp., Shelton, CT (US)

(72) Inventors: Daniel A. Landan, Milford, CT (US); Victor Ivenitsky, South Salem, NY (US); Roman D'Alessandro, Brookfield, CT (US)

(21) Appl. No.: 15/788,395

(22) Filed: Oct. 19, 2017

(51) Int. Cl. B65D 55/02; B65D 43/16; B65D 43/22; B29C 51/10

(52) U.S. Cl. CPC B65D 55/024; B65D 43/162; B29L 2031/7162; B29C 51/10; B65D 43/22

(57) ABSTRACT

A container includes a base and a lid. A peripheral wall of the base terminates in a sealing flange extending outward from the peripheral wall of the base. The sealing flange includes a rail and a rim defining a groove therebetween. An upper surface of the lid terminates in a downwardly extending peripheral shoulder and an outwardly extending peripheral flange positioned outward from the downwardly extending peripheral shoulder. The outwardly extending peripheral flange of the lid abuts the rim when the container is closed. The rim extends beyond an outer edge of the outwardly extending peripheral flange of the lid substantially around the perimeter of the container. At least one surface of the downwardly extending peripheral shoulder engages at least one surface of the groove at a seal interface. The rail impedes the downwardly extending peripheral shoulder from moving in a direction away from the seal interface.

### BACKGROUND OF THE INVENTION

### 1. Field of the Invention

The subject invention is directed to containers and packaging, and more particularly, to containers and packaging that incorporate features that ensure that the containers stay closed when they are intended to be in the closed position, deter unauthorized tampering, and/or clearly indicate whether unauthorized tampering has occurred.

### 2. Background of the Related Art

Disposable containers for packaging, distributing, displaying or otherwise housing consumer items, are becoming increasingly important. The advent of plastics resulted in many products being wrapped or packaged in plastic, both in the form of flexible plastic bags and rigid plastic containers. The use of plastics in the modern-day convenience food industry has significantly improved the “shelf life” of perishable products, allowing both merchants and their customers to store the products for longer periods of time, resulting in substantial savings.

It has been found that consumers like recloseable packages, particularly for comestible products, especially in circumstances where more than one serving of a comestible product is contained therein, in order to reduce drying out or other deterioration of the comestible food product. In addition, consumers prefer to visually inspect the product within such containers prior to purchase. Thus, fabricating containers from clear see-through plastics is desirable. In addition to the aforementioned consumer design preferences, it is desirable to fabricate containers that include features which ensure that the containers stay closed when they are intended to be in the closed position, deter unauthorized tampering, and/or clearly indicate whether unauthorized tampering has occurred.

Thus, there is a need for containers having design elements, such as recloseability features which are reliable and easy to operate, along with resistant features that deter unauthorized or unwanted opening of the container. Accordingly, the present invention is directed to a container that meets these needs.

### SUMMARY OF THE INVENTION

The subject disclosure relates to a container that includes a base and a lid. The base has a bottom and a peripheral wall extending upward from the bottom. The peripheral wall terminates in a sealing flange extending outward from the peripheral wall of the base. The sealing flange includes a rail and a rim defining a groove therebetween. The lid has an upper surface. The upper surface of the lid terminates in a downwardly extending peripheral shoulder and an outwardly extending peripheral flange positioned outward from the downwardly extending peripheral shoulder. The outwardly extending peripheral flange of the lid abuts the rim when the container is closed. The rim extends beyond an outer edge of the outwardly extending peripheral flange of the lid substantially around the perimeter of the container. At least one surface of the downwardly extending peripheral shoulder engages at least one surface of the groove at a seal interface to form a non-permanent press-fit seal between the base and the lid when the container is closed. The rail impedes the downwardly extending peripheral shoulder from moving in a direction away from the seal interface to deter unauthorized opening of the container when the container is closed.

In accordance with some embodiments, the at least one surface of the groove is an outer side surface of the groove, and the at least one surface of the downwardly extending peripheral shoulder is an outwardly facing surface of the downwardly extending peripheral shoulder. The rim can impede the downwardly extending peripheral shoulder from moving in an outward direction and the rail can impede the downwardly extending peripheral shoulder from moving in an inward direction when the container is closed. It is contemplated that the at least one surface of the groove can be an undercut surface on its outer periphery. The rail, the rim and the groove can extend around the entire perimeter of the base. The downwardly extending peripheral shoulder can extend around the entire perimeter of the lid. In some embodiments, the at least one surface of the downwardly extending peripheral shoulder can be an outwardly tapered shoulder surface.

In accordance with some embodiments, the upper surface of the lid includes a top wall and at least one peripheral wall extending downwardly from the top wall. The peripheral wall can be positioned between the top wall and the downwardly extending peripheral shoulder. At least a portion of the upper surface of the lid can be raised with respect to the outwardly extending peripheral flange. At least a portion of the downwardly extending peripheral shoulder of the lid can be recessed with respect to the outwardly extending peripheral flange.

In accordance with some embodiments, the rim includes an upwardly projecting bead extending substantially about the perimeter of the base. The upwardly projecting bead can surround an outer edge of the outwardly extending peripheral flange of the lid substantially about the perimeter of the base when the container is closed.

It is contemplated that the container can include a tamper-evident hinge joining the lid with the base. The tamper-evident hinge can include a frangible section. The frangible section can include at least one line of weakness. It is contemplated that the lid and the base can be thermoformed from a single sheet of plastic.

In accordance with another aspect, a method of forming a container includes providing a sheet of plastic material that is at least partially transparent and forming a lid from a portion of the sheet of plastic material. The lid can be similar to the lid described above. The method includes forming a base from a portion of the sheet of plastic material. The base can be similar to the base described above.

In accordance with some embodiments, the method includes forming a hinge from a portion of the sheet joining the lid with the base, wherein the lid, the base, and the hinge are unitarily formed from the sheet of plastic material.

It should be appreciated that the present invention can be implemented and utilized in numerous ways, including without limitation as a process, an apparatus, a system, a device, and a method for applications now known and later developed. These and other unique features of the system disclosed herein will become more readily apparent from the following description and the accompanying drawings.

### BRIEF DESCRIPTION OF THE DRAWINGS

So that those having ordinary skill in the art to which the disclosed system appertains will more readily understand how to make and use the same, reference may be had to the drawings wherein:

FIG. 1 is a perspective view a container constructed in accordance with an embodiment of the present invention, showing the container in a closed position;

FIG. 2 is a perspective view of the container of FIG. 1, showing the container in an open position and showing the rail of the base.

FIG. 3 is a cross sectional view of a portion of the container shown in FIG. 1, taken along line 3-3 of FIG. 1 when the container is in a closed position, showing the downwardly extending peripheral shoulder of the lid engaged with the groove of the base; and

FIG. 4 is a cross sectional view of a portion of the container shown in FIG. 1, taken along line 3-3 of FIG. 1 when the container is in a closed position, showing an alternative embodiment of the arrangement between the outwardly extending peripheral flange of the lid and the rim of the base.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment

### DETAILED DESCRIPTION OF PREFERRED EMBODIMENTS

Disclosed herein are detailed descriptions of specific embodiments of containers for protecting baked goods during shipment and methods of constructing the same. It will be understood that the disclosed embodiments are merely examples of the way in which certain aspects of the invention can be implemented and do not represent an exhaustive list of all of the ways the invention may be embodied. Indeed, it will be understood that the systems, devices and methods described herein may be embodied in various and alternative forms. Moreover, the figures are not necessarily to scale and some features may be exaggerated or minimized to show details of particular components.

Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

Unless otherwise apparent, or stated, directional references, such as “right,” “left,” “upper,” “lower,” “outward,” “inward,” etc., are intended to be relative to the orientation of a particular embodiment of the invention as shown in the first numbered view of that embodiment. In addition, a given reference numeral indicates the same or similar structure when it appears in different figures and like reference numerals identify similar structural elements and/or features of the subject invention.

The present disclosure now will be described more fully, but not all embodiments of the disclosure are necessarily shown. In addition, many modifications may be made to adapt a particular situation or material to the teachings of the disclosure without departing from the essential scope thereof.

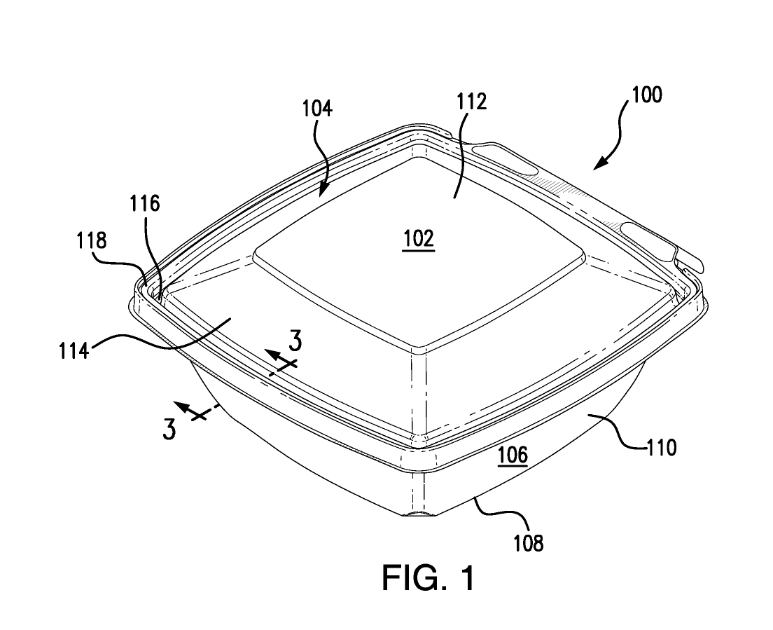

Referring now to FIG. 1, a container 100 includes a lid 102 having an upper surface 104. The container 100 includes a base 106 having a bottom 108 and a peripheral wall 110 extending upward from the bottom 108. The upper surface 104 of the lid 102 terminates in a downwardly extending peripheral shoulder 116. The upper surface 104 of the lid 102 includes a top wall 112 and a peripheral wall 114 extending downwardly from the top wall 112. The peripheral wall 114 is positioned between the top wall 112 and the downwardly extending peripheral shoulder 116. The lid 102 terminates in an outwardly extending peripheral flange 118 positioned outward from the downwardly extending peripheral shoulder 116. The upper surface 104 of the lid 102 is raised with respect to the outwardly extending peripheral flange 118. The downwardly extending peripheral shoulder 116 of the lid 102 is recessed with respect to the outwardly extending peripheral flange 118 and extends around the entire perimeter of the lid 102.

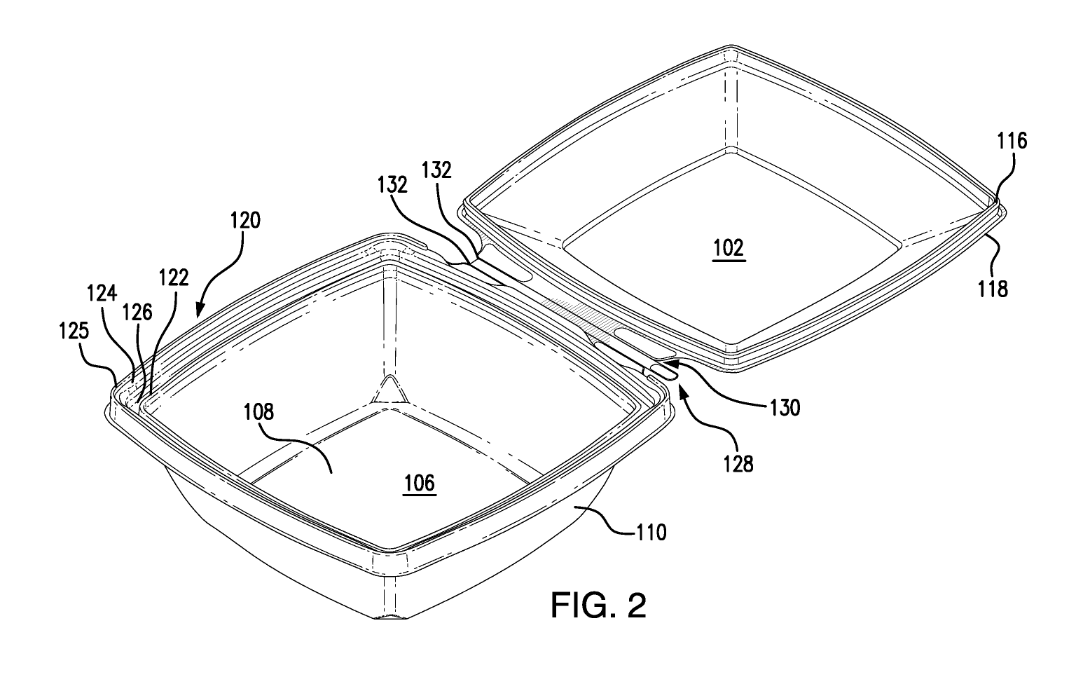

As shown in FIG. 2, the peripheral wall 110 of the base 106 terminates in a sealing flange 120 extending outward from the peripheral wall 110 of the base 106. The sealing flange 120 includes a rail 122 and a rim 124 defining a groove 126 therebetween. The rail 122, the rim 124 and the groove 126 extend around the entire perimeter of the base 106. The container 100 includes a tamper-evident hinge 128 joining the lid 102 with the base 106. The tamper-evident hinge 128 can include a frangible section 130. The frangible section 130 can include at least one line of weakness 132. In the embodiment of FIG. 2, the container 100 includes two lines of weakness 132, e.g. score lines.

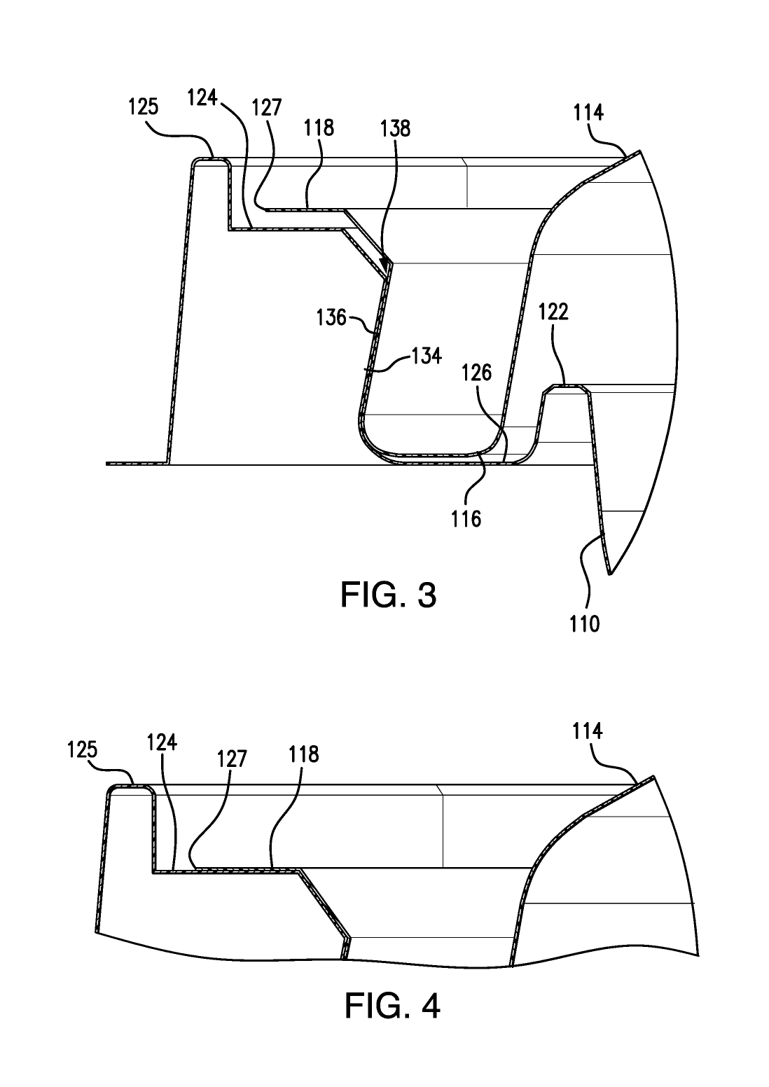

As shown in FIGS. 2-4, the outwardly extending peripheral flange 118 of the lid 102 abuts the rim 124 when the container 100 is closed. The term “abuts” in this context may mean very close physical proximity instead of direct physical contact. For example, there may be a small gap between peripheral flange 118 and rim 124, as shown in the enlarged cross-sectional view of FIG. 3. Because of this very close physical proximity, or abutment, the gap may not be visible to the human eye without close inspection and thus, the rim 124 and peripheral flange 118 may appear to be in direct physical abutment. In the alternative, as shown in FIG. 4, there may be no gap at all depending on manufacturing tolerances, material thicknesses, etc.

With reference now to FIG. 3, an outer side surface 134 of the groove 126, shown as an undercut surface on the outer periphery of the groove 126, and an outwardly facing surface 136 of the downwardly extending peripheral shoulder 116 of the lid 102 engage one another at a seal interface 138 to form a non-permanent press-fit seal between the base 106 and the lid 102 when the container 100 is closed. The outwardly facing surface 136 is an outwardly tapered shoulder surface. The rail 122 acts to impede the downwardly extending peripheral shoulder 116 from moving in a direction away from the seal interface 138, e.g. inward, when the container 100 is closed to deter unauthorized opening of the container. This impediment, for example, tends to make it difficult for a user to use the upper surface 104 of the lid 102, such as the peripheral wall 114, to release the engagement at the seal interface 138 and gain access to the contents of the container 100 without severing a portion of the tamper evident hinge 128.

With continued reference to FIGS. 3 and 4, in some embodiments, the rim 124 extends beyond an outer edge of the outwardly extending peripheral flange 118 of the lid 102 substantially around the perimeter of the container 100 to further deter unauthorized opening of the container 100 when the container 100 is closed. It is also contemplated that in some embodiments, the rim 124 includes an upwardly projecting bead 125 extending substantially about the perimeter of the base 106. The upwardly projecting bead 125 surrounds an outer edge 127 of the outwardly extending peripheral flange 118 of the lid 102 substantially about the perimeter of the base 106 when the container 100 is closed to further deter unauthorized opening of the container 100. It is contemplated that peripheral flange 118 is small enough that, even if physical access to peripheral flange 118 is not blocked or rendered inaccessible by the bead 125, the overlapping abutment between peripheral flange 118 and rim 124 and the small size of flange 118 is sufficient to hinder access to flange 118 and make it difficult for a user to use flange 118 to open the container 100. In other words, even if a consumer can lift the flange 118, the lifting force required to remove the lid 102 from base 104 cannot easily be transmitted through flange 118 because of its small size. Alternatively, even without flange 118, the lateral abutment between a surface of the downwardly extending peripheral shoulder 116 and base 106 is sufficient to hinder access to the lid of the container 100.

In accordance with another aspect, a method of forming a container, e.g. the container 100, includes providing a sheet of plastic material that is at least partially transparent and forming a lid, e.g. the lid 102, from a portion of the sheet of plastic material. The lid can be similar to the lid 102 described above. The method includes forming a base, e.g. the base 106, from a portion of the sheet of plastic material. The base can be similar to the base 106 described above. In embodiments where the container has a hinge, the method includes forming a hinge from a portion of the sheet joining the lid 102 with the base 106, wherein the lid 102, the base 106, and the hinge are unitarily formed from the sheet of plastic material. It is contemplated that the method can include forming a hinge, e.g. the hinge 128, with a frangible portion, e.g. score lines as described above. It is contemplated that the lid and the base can be thermoformed from a single sheet of plastic.

It should be readily understood that a container 100 constructed in accordance with the present invention, which is preferably a plastic container used for carrying edible items, can be manufactured in a variety of shapes and sizes, and can be formed from resins or plastic materials such as polyethylene, polypropylene, polyvinyl chloride or polyethylene terephthalate (“PETE”), as well as other suitable materials or combinations thereof. The forming process can also vary to include methods such as thermo-forming, injection molding or blow molding. The container can be transparent or translucent, and may be colored in either instance. Also, vents can be provided in the container to promote airflow therethrough, if appropriate based on the intended contents of the container. Preferably, container is formed from a roll of PETE subjected to a vacuum and pressure mold with plug assist.

1. A container, comprising:
a base including a bottom and a peripheral wall extending upward from the bottom, wherein the peripheral wall terminates in a sealing flange extending outward from the peripheral wall of the base, wherein the sealing flange includes a rail and a rim defining a groove there between; and
a lid including an upper surface, wherein the upper surface of the lid terminates in a downwardly extending peripheral shoulder and an outwardly extending peripheral flange positioned outward from the downwardly extending peripheral shoulder, wherein the outwardly extending peripheral flange of the lid abuts the rim when the container is closed, wherein the rim extends beyond an outer edge of the outwardly extending peripheral flange of the lid substantially around the perimeter of the container, wherein at least one surface of the downwardly extending peripheral shoulder engages at least one surface of the groove at a seal interface to form a non-permanent press-fit seal between the base and the lid when the container is closed, wherein the rail impedes the downwardly extending peripheral shoulder from moving in a direction away from the seal interface to deter unauthorized opening of the container when the container is closed.

2. The container as recited in claim 1, wherein the at least one surface of the groove is an outer side surface of the groove, and wherein the at least one surface of the downwardly extending peripheral shoulder is an outwardly facing surface of the downwardly extending peripheral shoulder, wherein the rim impedes the downwardly extending peripheral shoulder from moving in an outward direction and the rail impedes the downwardly extending peripheral shoulder from moving in an inward direction when the container is closed.

3. The container as recited in claim 1, wherein the at least one surface of the groove is an undercut surface on its outer periphery.

4. The container as recited in claim 1, wherein the at least one surface of the downwardly extending peripheral shoulder is an outwardly tapered shoulder surface.

5. The container as recited in claim 1, wherein the upper surface of the lid includes a top wall and at least one peripheral wall extending downwardly from the top wall, wherein the at least one peripheral wall is positioned between the top wall and the downwardly extending peripheral shoulder.

6. The container as recited in claim 1, wherein the lid terminates in an outwardly extending peripheral flange positioned outward from the downwardly extending peripheral shoulder, wherein at least a portion of the upper surface of the lid is raised with respect to the outwardly extending peripheral flange.

7. The container as recited in claim 6, wherein at least a portion of the downwardly extending peripheral shoulder of the lid is recessed with respect to the outwardly extending peripheral flange.

8. The container as recited in claim 1, wherein the rim includes an upwardly projecting bead extending substantially about the perimeter of the base, wherein the upwardly projecting bead surrounds an outer edge of the outwardly extending peripheral flange of the lid substantially about the perimeter of the base when the container is closed.

9. The container as recited in claim 1, wherein the rail, the rim and the groove extend around the entire perimeter of the base.

10. The container as recited in claim 1, wherein the downwardly extending peripheral shoulder extends around the entire perimeter of the lid.

11. The container as recited in claim 1, further comprising a tamper-evident hinge joining the lid with the base, the tamper-evident hinge including a frangible section.

12. The container as recited in claim 11, wherein the frangible section includes at least one line of weakness.

13. The container as recited in claim 1, wherein the lid and the base are thermoformed from a single sheet of plastic.

14. A method of forming a container, comprising:
a) providing a sheet of plastic material that is at least partially transparent;
b) forming a base from a portion of the sheet of plastic material, wherein the base includes a bottom and a peripheral wall extending upward from the bottom, wherein the peripheral wall terminates in a sealing flange extending outward from the peripheral wall of the base, wherein the sealing flange includes a rail and a rim defining a groove there between; and
c) forming a lid from a portion of the sheet of plastic material, wherein the lid includes an upper surface, wherein the upper surface of the lid terminates in a downwardly extending peripheral shoulder and an outwardly extending peripheral flange positioned outward from the downwardly extending peripheral shoulder, wherein the outwardly extending peripheral flange of the lid abuts the rim when the container is closed, wherein the rim extends beyond an outer edge of the outwardly extending peripheral flange of the lid substantially around the perimeter of the container, wherein at least one surface of the downwardly extending peripheral shoulder engages at least one surface of the groove at a seal interface to form a non-permanent press-fit seal between the base and the lid when the container is closed, wherein the rail impedes the downwardly extending peripheral shoulder from moving in a direction away from the seal interface to deter unauthorized opening of the container when the container is closed.

15. The method as recited in claim 14, further comprising forming a hinge from a portion of the sheet joining the lid with the base, wherein the lid, the base, and the hinge are unitarily formed from the sheet of plastic material.
